(19) United States
(12) Patent Application Publication
(10) Pub. No.: US 2021/0184396 A1
(43) Pub. Date: Jun. 17, 2021

(54) ASSEMBLY FOR CHARGING A BATTERY AND CHARGING METHOD IMPLEMENTING SUCH AN ASSEMBLY

(71) Applicant: SOFTBANK ROBOTICS EUROPE, PARIS (FR)

(72) Inventors: Thierry LABAYE, PARIS (FR); Vincent CLERC, CLAMART (FR)

(21) Appl. No.: 16/079,506

(22) PCT Filed: Feb. 27, 2017
(86) PCT No.: PCT/EP2017/054519

§ 371 Date: Aug. 23, 2018

(30) Foreign Application Priority Data
Mar. 2, 2016 (FR) 1651785

(51) Int. Cl. H01R 13/62; H01R 13/24; H01R 13/66; H01R 43/26

(52) U.S. Cl. CPC H01R 13/6205; H01R 13/2478; H02J 7/0045; H01R 43/26; H01R 13/6683

(57) ABSTRACT

A charging assembly includes an object comprising a battery and a plug intended to charge the battery, the plug being capable of being connected to an electricity source. The object comprises a base suitable for receiving the plug, comprising a first electrical connector, a first magnetic connector suitable for positioning the plug with respect to the base. The plug comprises a contact surface, the shape of which is complementary to a surface of the base, a second electrical connector positioned so as to come into contact with the first electrical connector in order to allow electrical contact between the first and second electrical connectors when the contact surface is positioned on the surface of the base, a second magnetic connector, positioned in proximity to the contact surface, attracting the first magnetic connector, so as to allow the first and second electrical connectors to be aligned and electrical contact to be maintained during the charging of the battery. One of the first and second electrical connectors is a surface connector and the other of the first and second electrical connectors is a point connector that is positioned so as to rest against the surface connector, for multiple separate orientations of the contact surface on the base.

The invention relates to a recharging assembly comprising an object and a plug for recharging a rechargeable battery of the object. The invention can be applied to any field requiring the recharging of a battery, for example telephony or robotics. The invention relates also to a method for recharging a rechargeable battery implementing such an assembly.

An object operating on battery requires, at a given moment, a recharge of its battery. This object is then connected to a power source via a specific device allowing its battery to be recharged.

Nevertheless, it may be that there are difficulties in connecting the object to the recharging device, either because of a poor positioning of the device relative to the object, or because of poor contacts between the connectors of the object and of the device. Moreover, it may be that, when the object is connected to its recharging device, electrical arcs are created between the electrical connectors of the object and of the recharging device, potentially damaging the object and/or the device.

The object can also be a mobile vehicle, more specifically a motor vehicle, that is to say mobile by its own means. A mobile vehicle can be supplied with electricity by one or more storage batteries, or, more commonly, one or more batteries. It concerns a set of electrical storage batteries linked to one another so as to create an electrical voltage generator of desired capacity. The first aim of the battery is to supply the current intensity and the voltage necessary to the movement of the vehicle. The battery can also be used to power the electronic gear embedded on the vehicle.

It is then necessary, at a given moment, to recharge the battery of the object or of the vehicle. Generally, a vehicle operating on battery is capable of moving around as long as the battery is charged and becomes immobile at the end of charge thereof. An outside intervention is then needed to, for example, place the vehicle on a battery recharging base. The same problems as those cited above can occur: difficulties of connection between the vehicle and its base and/or creation of undesirable electrical arcs.

Furthermore, during the recharging thereof, the vehicle, having to remain positioned on its base, is then inactive for the time taken for its battery to be recharged. As for an object, when the latter is recharging, it must remain on its recharging base, which prevents it from being moved.

The invention aims to overcome all or some of the problems cited above by proposing a recharging assembly comprising an object having a battery, the object being able to be an immobile object or a mobile vehicle, and a plug intended to recharge the battery of the object, the plug being able to be connected to a power source, and a method implementing such an assembly, allowing any object to be recharged with a simplified connection between the plug and the object. The recharging assembly according to the invention is also configured so as to allow a mobile vehicle to move around, even while its battery is recharging.

To this end, the subject of the invention is a recharging assembly comprising an object comprising a battery, a plug intended to recharge the battery, the plug being able to be connected to a power source, the object comprising a base capable of receiving the plug, comprising a first electrical connector, a first magnetic connector capable of positioning the plug relative to the base, the plug comprising a contact surface of a form complementing a surface of the base, a second electrical connector arranged so as to enter into contact with the first electrical connector to allow an electrical contact between the first and second electrical connectors when the contact surface is positioned on the surface of the base, a second magnetic connector, positioned in proximity to the contact surface, attracting the first magnetic connector, so as to allow the alignment of the first and second electrical connectors and the electrical contact to be secured while the battery is recharging, and one out of the first and the second electrical connectors is a surface connector and the other out of the first and the second electrical connectors is a spot connector arranged so as to be placed against the surface connector, for several distinct orientations of the contact surface on the base.

Advantageously, the surface connector has a circular form.

Advantageously, the recharging assembly also comprises a presence detector capable of detecting a contact between the contact surface and the surface of the base.

According to an embodiment, the spot connector forming a first point of contact with the contact surface, the assembly is configured in such a way that one out of the first and the second electrical connectors has a degree of freedom in translation relative to the contact surface along a first axis substantially at right angles to the contact surface passing through the first point of contact.

Advantageously, the assembly is configured in such a way as to generate a force along the first axis substantially at right angles to the contact surface passing through the first point of contact to secure the electrical contact while the battery is recharging.

According to another embodiment, the plug can be connected to the power source by an electrical cable, the plug comprising a body onto which the second electrical connector and the second magnetic connector are fixed, a part that is rotationally mobile relative to the body, the cable being fixed to the mobile part and linked electrically to the connectors by flexible wires allowing the rotation of the mobile part.

According to another embodiment, the base comprises a cavity having the complementary form of a spherical cap having a first pole and a first radius, the plug has the form of a spherical cap having a second pole and of a radius substantially equal to the first radius, and the surface connector is centered on a circle whose center is the first pole.

Advantageously, the plug comprises a third electrical connector positioned on the second pole of the plug, the base comprises a fourth electrical connector positioned on the first pole of the base, so as to enter into contact with the third electrical connector to allow an electrical contact between the third and fourth electrical connectors when the contact surface is positioned on the base.

Advantageously, the power source is a DC voltage source with a positive pole and a negative pole, the third electrical connector is connected to the negative pole of the power source and the second electrical connector is connected to the positive pole of the power source.

According to another embodiment, the contact surface comprises a flexible zone having a degree of freedom in translation along a second axis substantially at right angles to the first axis, intended to facilitate the contact of the second electrical connector with the first electrical connector when the contact surface is positioned on the base.

Another subject of the invention is a recharging method implementing such a recharging assembly comprising the following steps:

Positioning of the contact surface on the surface of the base, Alignment of the first and second electrical connectors.

Advantageously, the recharging method also comprises a step of activating of the recharging comprising the following steps:

Verification of the presence of the plug on the object by the presence detector,

Measurement of the voltage at the terminals of the battery and comparison of the measured voltage to a minimum voltage value and a maximum voltage value,

Measurement of the internal resistance of the battery and comparison of the measured resistance to a minimum resistance value and a maximum resistance value.

Advantageously, the recharging method also comprises a step of termination of recharging comprising the following steps performed in the following order:
Disconnection of the second electrical connector and of the first electrical connector,
Disconnection of the fourth electrical connector and of the third electrical connector.

The object can be any object having a battery and that can be recharged. It can be an object such as a telephone, a toy or else it can concern a mobile object such as a motor vehicle, that is to say which moves around by its own means, for example a robot.

The invention will be better understood and other advantages will become apparent on reading the detailed description of an embodiment given by way of example, the description being illustrated by the attached drawing in which:

FIG. 1 schematically represents the plug of the recharging assembly according to the invention,

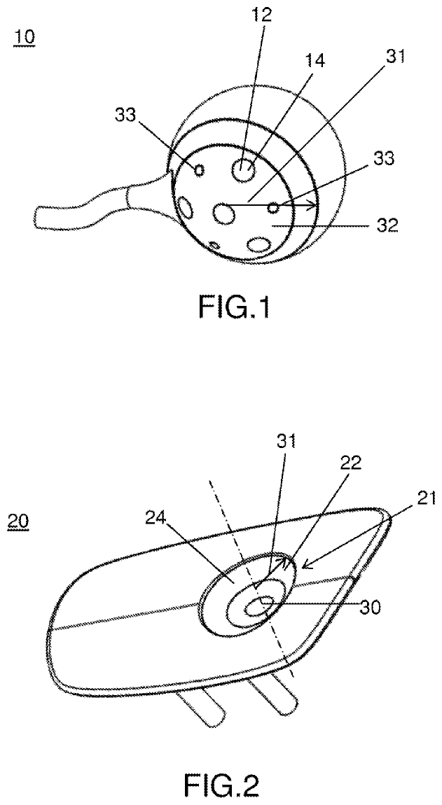

FIG. 2 represents an example of a surface of the base of the recharging assembly according to the invention,

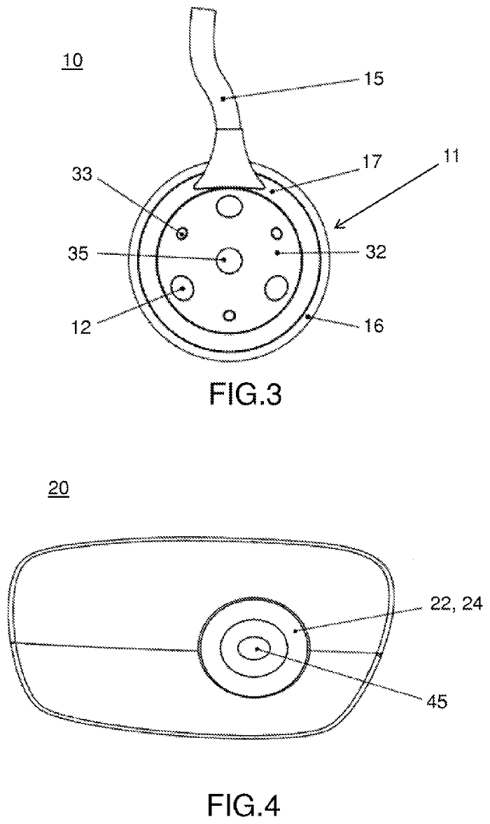

FIG. 3 schematically represents a front view of the contact surface of the plug of the recharging assembly according to the invention,

FIG. 4 represents a front view of a surface of the base that can receive the plug of the recharging assembly presented in FIG. 3 according to the invention,

FIG. 5 schematically represents a cross-sectional view of an electrical connector of the plug of the recharging assembly according to the invention,

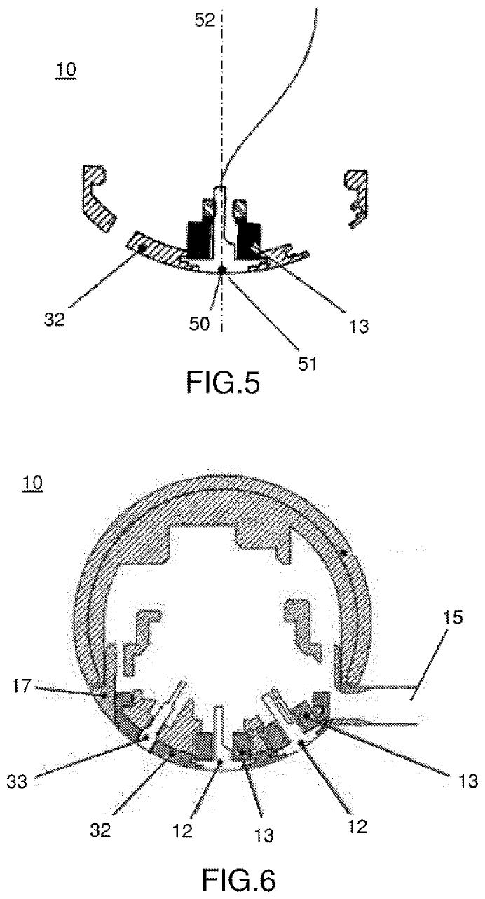

FIG. 6 schematically represents a cross-sectional view of the plug of the recharging assembly according to the invention,

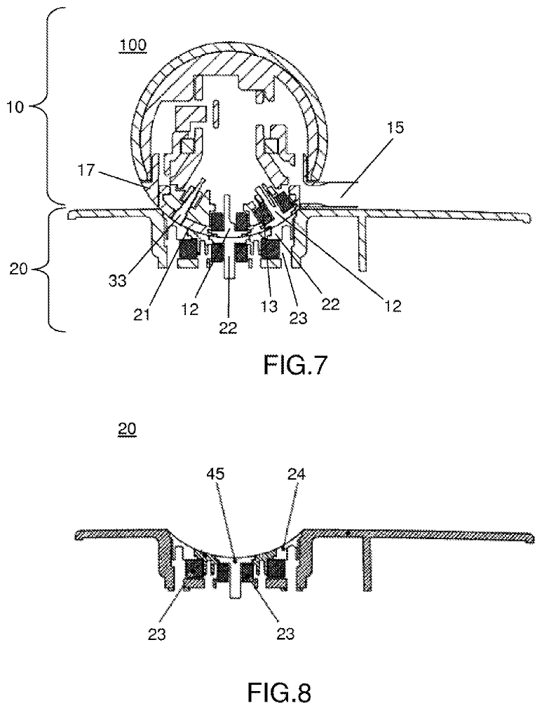

FIG. 7 schematically represents a cross-sectional view of the plug of the recharging assembly according to the invention, the contact surface of the plug being in contact with the surface of the base of the object,

FIG. 8 schematically represents a cross-sectional view of the object of the recharging assembly according to the invention,

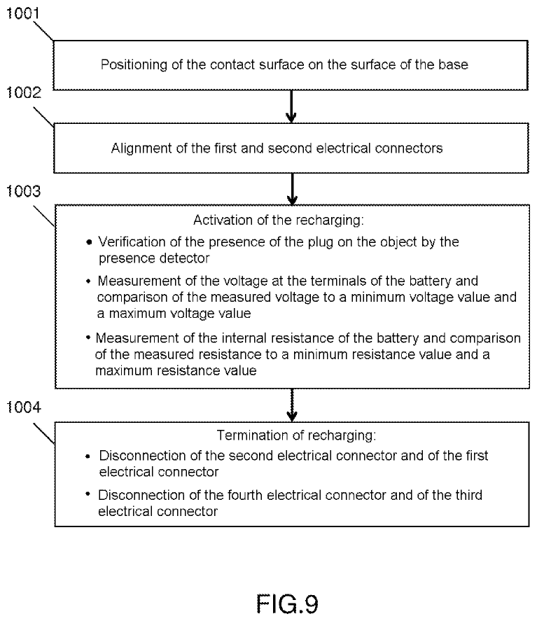

FIG. 9 illustrates the steps of a recharging method implementing a recharging assembly according to the invention,

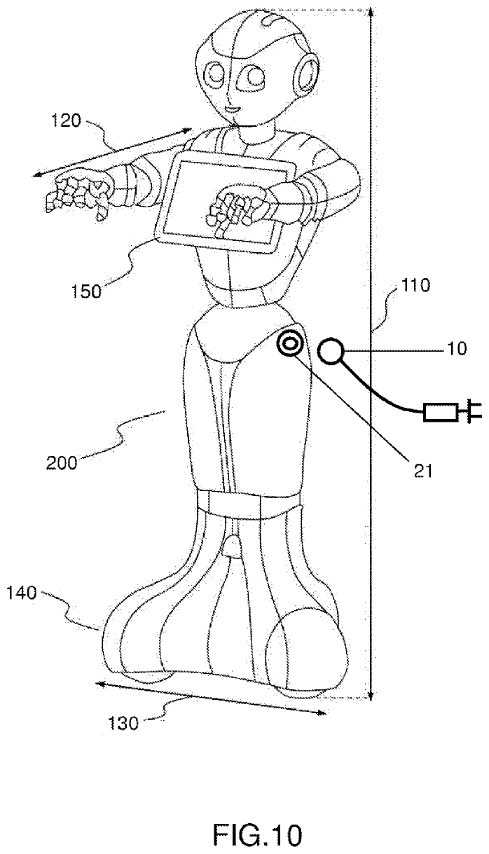

FIG. 10 represents a humanoid robot configured to be recharged using a plug of a recharging assembly according to the invention.

In the interests of clarity, the same elements will bear the same references in the different figures.

In the description, the invention is described with the example of an object. However, the invention is applicable to any other object, whether it be immobile or mobile, that is to say any mobile vehicle having a battery that can be recharged.

FIG. 1 schematically represents a plug 10 of a recharging assembly 100 according to the invention.

FIG. 2 represents an example of a surface of the object 20 of the recharging assembly 100 according to the invention.

The recharging assembly 100 comprises an object 20 comprising a battery and a plug 10 intended to recharge the battery. The plug 10 can be connected to a power source.

As can be seen in FIG. 2, the object 20 comprises a base 21 capable of receiving the plug 10. The base 21 comprises a first electrical connector 22 and a first magnetic connector 23 (not visible in FIG. 2) capable of positioning the plug 10 relative to the base 21.

In this application, a connector, whether it be electrical or magnetic, should be understood to be a contact element, that is to say a point or a surface, making it possible to create a connection, respectively electrical or magnetic.

As can be seen in FIG. 1, the plug 10 comprises a contact surface 11 of a form complementing a surface of the base 21. The plug comprises a second electrical connector 12 arranged in such a way as to enter into contact with the first electrical connector 22 to allow an electrical contact between the first and second electrical connectors 22, 12 when the contact surface 11 is positioned on the surface of the base 21. The plug 10 comprises a second magnetic connector 13 (not visible in FIG. 1), positioned in proximity to the contact surface 11, attracting the first magnetic connector 23, so as to allow the alignment of the first and second electrical connectors 22, 12 and the electrical contact to be secured while the battery is recharging.

According to the invention, one out of the first and the second electrical connectors 22, 12 is a surface connector 24 and the other out of the first and the second electrical connectors 22, 12 is a spot connector 14 arranged in such a way as to be placed against the surface connector 24, for several distinct orientations of the contact surface 11 on the base 21.

Since the contact surface 11 is of a form complementing the surface of the base 21 comprising the first electrical connector 22, the two surfaces are in contact against one another while the battery is recharging. The two magnetic connectors 23, 13 are respectively positioned in proximity to the surface of the base 21 and the contact surface 11. Attracting the first magnetic connector, by offering the plug 11 up to the base 21, the two magnetic connectors 23, 13 exert a force of attraction to one another. The two magnetic connectors 23, 13 are positioned in such a way that the two electrical connectors 22, 12 are in contact against one another when the two magnetic connectors 23, 13 exert a force of attraction to one another.

The invention is described with a magnetic connector in the plug 10 and a magnetic connector in the base 21, but it also includes the configurations in which the plug 10 comprises several magnetic connectors 13 and the base 21 comprises several magnetic connectors 23, advantageously the same number of magnetic connectors as the plug, but not necessarily.

The magnetic connectors 13, 23 make it possible to maintain an optimal electrical contact of the electrical connectors 12, 22 to one another. They also serve as polarizers and ensure the self-alignment between the plug 10 and the base 21.

According to an advantageous embodiment, the surface connector 24 has a circular form.

Moreover, one of the electrical connectors 22, 12 being a surface connector 24 and the other being a spot connector 14 arranged so as to come into contact against the surface connector 24, and with one or a plurality of magnetic connectors distributed respectively in the plug 10 and the base 21, it is possible to establish the electrical contact between the plug 10 and the base 21 regardless of the orientation of the contact surface 11 of the plug 10 relative to the base 21, and do so for several distinct orientations of the contact surface 11 relative to the surface of the base 21. For example, with a surface connector 24 in the form of a ring, as represented in FIG. 2, the spot connector 14 can enter into contact with the surface connector 24 regardless of the orientation of the contact surface 11 of the plug 10 on the base 21. In other words, the contact surface 11 can assume any position about a rotation of 360° relative to the surface of the base 21. If an axis is considered that passes through the center of the ring and is substantially at right angles to a plane comprising a perimeter of the ring, the plug 10 and therefore its contact surface 11 can assume an initial position but also perform a rotation about said axis relative to the surface of the base 21, of any angle ranging from 0 to 360°, and, whatever the angle, the spot connector 14 is in contact against the surface connector 24. This applies also to the case where the surface connector 24 is of polygonal form, for example rectangular. The same spot connector 14 can form an electrical contact with said surface connector 24 for several distinct orientations of the contact surface 11 relative to the base 21.

This configuration is advantageous both in the phase of offering up the plug 10 to the object 20 in the placement of the plug 10 on the base 21 since it is not necessary to observe a particular alignment of the contact surface 11 of the plug 10 relative to the surface of the base 21 to make a contact between the two electrical connectors 12, 22, but also when the battery is recharging since, once the contact is made between the two electrical connectors 12, 22, the plug can retain a little rotational mobility without in any way breaking the electrical contact between the two electrical connectors 12, 22. Indeed, once the electrical contact is established, an external action may move the plug 10, sliding it slightly over the surface of the base 21. By virtue of the contact between the surface connector 24 and the spot connector 14 and the allowable degree of rotation, the electrical contact can be maintained.

The surface connector 24 can be of circular form. In FIG. 2, it is a ring. The invention applies also to a surface connector 24 forming a circle, that is to say a ring of very small thickness. The invention applies also to a surface connector 24 that is a portion of a circle or a portion of a ring. In this case, the angle cited previously no longer lies between 0 and 360°. For example, if the portion of circle or the portion of ring is a semicircle or a half-ring, the angle then lies between 0 and 180°. If the portion of circle or the portion of ring is a quarter circle or a quarter ring, the angle then lies between 0 and 90°.

The invention makes it possible to remove the link between the mechanical contact and the electrical contact. Thus, there is complete freedom from the positioning tolerances between the electrical contacts and the mechanical structure which allows the positioning of the plug 10 relative to the base 21. In other words, the invention makes it possible to establish an electrical contact between the electrical connectors for several distinct orientations of the plug relative to the base. A single spot connector 14 can therefore produce an electrical contact with the surface connector 24 for a multitude of positionings of the plug 10 on the base 21.

As explained previously, one of the electrical connectors 22, 12 is advantageously a surface connector 24 and the other is a spot connector 14. In FIGS. 1 and 2, the first electrical connector 22 is the surface connector 24 and the second electrical connector 12 is the spot connector 14. This is the configuration in which the surface connector 24 is on the base 21 and the spot connector 14 is on the contact surface 11 of the plug 10. Nevertheless, the invention also includes the configuration in which the surface connector 24 is on the contact surface 11 of the plug 10 and the spot connector 14 is on the base 21.

The invention also includes the configuration in which there are several spot connectors 14. The use of several spot connectors 14 makes it possible to reduce the risks of short-circuit between the contact surface 11 and the base 21.

In a preferred embodiment, and as represented in FIGS. 1 and 2, the base 21 comprises a cavity having the complementary form of a spherical cap having a first pole 30 and a first radius 31. The plug 10 has the form of a spherical cap having a second pole and of a radius substantially equal to the first radius 31, and the surface connector 24 is centered on a circle whose center is the first pole 30.

This configuration is particularly advantageous for forming the electrical contact. Thus, the surface connector 24 forms a part of the surface making the contact, either on the contact surface 11 or on the surface of the base 21, and the spot connector 14, arranged on the surface of the surface, either of the base 21, or on the contact surface 11, can form the electrical contact with the surface connector 24, whatever the point at which the contact is made on the surface connector 24.

This configuration therefore allows the plug to be positioned perfectly on the base in order to ensure the alignment of the electrical connectors and an electrical contact necessary for the passage of the battery charging current to be maintained. The spherical portion forms for the plug and the base allow them to be stuck one against the other, the base 21 completely matching the form of the plug 10.

It can be noted that the plug in the form of a spherical cap and the base of a form complementing the spherical cap is a particularly advantageous configuration as explained previously and hereinbelow. Nevertheless, the invention applies similarly to two planar surfaces (contact surface 11 and surface of the base 21) which are pressed against one another or to a cubic plug with a base of a complementary form for receiving the cube of the plug, or else to a plug of octagonal section with a base of complementary form or, more generally, a plug having an oval or polygonal section with a base of complementary form and, for each of the configurations, the spot connector is pressed against the surface connector. In other words, the contact between the spot connector and the surface connector is made on the surface of the element (base or contact surface) comprising the surface connector. The spot connector is therefore in contact with the surface of the element (base or contact surface of the plug depending on the chosen configuration) comprising the surface connector (it is the base in FIG. 2) and this physical contact of the spot connector with the surface of the element also corresponds to the contact between the spot connector and the surface connector.

The recharging assembly 100 can also advantageously comprise a presence detector 33 capable of detecting a contact between the contact surface 11 and the surface of the base 21. The presence detector 33 makes it possible to detect the presence of the contact surface 11 against the surface of the base 21. When this contact is made, the charge of the battery can then begin.

In FIG. 1, the presence detector 33 is on the contact surface 11. Just as for the spot connector, the invention also includes the configuration in which the presence detector is on the surface of the base 21 when the surface connector 24 is on the contact surface 11 of the plug 10.

FIG. 1 is represented with three presence detectors 33. The invention applies likewise to just one, two, three or more than three presence detector(s).

Advantageously, the number of presence detectors 33 is equal to the number of spot connectors 14 and the presence detectors 33 and the spot connectors 14 are arranged alternately on a circumference of the surface, that is to say on contact sphere portion.

FIG. 3 schematically represents a front view of the contact surface 11 of the plug 10 of the recharging assembly 100 according to the invention. The plug 10 can be connected to the power source by an electrical cable 15. The plug 10 comprises a body 16 to which the second electrical connector 12 and the second magnetic connector 13 are fixed. The plug 10 also comprises a part 17 that is rotationally mobile relative to the body 16, the cable 15 being fixed to the mobile part 17 and linked electrically to the connectors 12 by flexible wires allowing the rotation of the mobile part 17. This feature offers an advantage in terms of safety for the object (immobile or mobile) and for people in the vicinity when the battery is charging. Indeed, when the battery is charging, the object being linked to a cable, there is a risk of a person crossing the electrical cable accidentally in his or her path and falling and/or causing the object to fall. However, by virtue of the part 17 that is rotationally mobile relative to the body 16, if something (or someone) comes into contact with the cable, depending on the type of contact, the mobile part 17 can have a rotational movement relative to the body 16 without being disconnected from the base 21, nor even requiring the movement of any part of the base or of the plug. In other words, the electrical cable 15 can have a continuous rotational movement of 360° about the base 21, even during recharging. If the contact imposes greater forces, the plug 10 can then be disconnected from the base 21.

The rotational mobility of the mobile part 17 can be about the plug but also about the axis of the cable.

FIG. 4 represents a front view of a surface of the base 21 that can receive the plug 10 of the recharging assembly 100 presented in FIG. 3 according to the invention. According to another embodiment, the plug 10 can comprise a third electrical connector 35 positioned on the second pole of the plug 10. The base 21 can then comprise a fourth electrical connector 45 positioned on the first pole of the base 21 so as to enter into contact with the third electrical connector 35 to allow an electrical contact between the third and fourth electrical connectors 35, 45 when the contact surface 11 is positioned on the base 21. In the case of a plug 10 in the form of a spherical cap and of a base 21 of complementary form, the fourth electrical connector 45 forms a central block, situated at the center of the surface connector 24. The surface connector 24 and the fourth electrical connector 45 are advantageously concentric.

FIG. 5 schematically represents a cross-sectional view of an electrical connector of the plug 10 of the recharging assembly 100 according to the invention. It is a spot connector 50. The spot connector 50 forms a first point of contact 51 with the contact surface 11. According to the invention, the assembly 100 is configured in such a way that one out of the first and the second electrical connectors has a degree of freedom in translation relative to the contact surface 11 along a first axis 52 substantially at right angles to the contact surface 11 passing through the first point of contact 51. This applies to each of the spot connectors. This degree of freedom allows a slight radial and independent movement of each spot connector. The presence detectors, for their part, are rigidly mounted and directly undergo the forces supported by the cable. The movements of the cable are passed on to one or more presence detectors which, distributed on the surface of the portion of sphere, are raised and break the physical contact between the plug and the base. The flexibility of mounting of the electrical connectors associated with the force holding the magnetic connectors in place introduces a delay to the breaking of the charging contact, contrary to the presence detectors which react immediately. This sequencing allows the presence detectors to inform the charger of an imminent pulling out of the plug and do so in phase advance with the break of the electrical contact. The power delivered can then be cut so as to avoid the formation of electrical arcs between the electrical connectors.

Advantageously, the contact surface 11 comprises a flexible zone 32 having a degree of freedom in translation along a second axis substantially at right angles to the first axis 51, intended to facilitate the contact of the second electrical connector 12 with the first electrical connector 22 when the contact surface 11 is positioned on the base 21. The flexible zone 32 allows the electrical connectors of the plug 11 a certain freedom to guarantee an appropriate contact with the plug 11 and the base 21. The flexibility of the flexible zone 32 thus allows the second electrical connector 12 to be advantageously oriented along an axis at right angles to the surface of the base 21.

The alternate distribution of the electrical connectors and of the presence detectors, associated with the magnetic connectors, offers the advantage of not requiring a fine alignment system and works regardless of the position of the spot connectors on the surface connector.

According to an embodiment, the power source is a DC voltage source with a positive pole and a negative pole. Advantageously, the third electrical connector 35 is connected to the negative pole of the power source and the second electrical connector 12 is connected to the positive pole of the power source. By virtue of the flexible zone 32 and of the central positioning of the third electrical connector 35, if a case of unwanted pulling-out of the plug 10 occurs, the third connector 35 is detached from the base last, which makes it possible to avoid the formation of an electrical arc. The third electrical connector 35 can for example be mounted on a spring or on a part made of elastomer or any other part having a certain elasticity. On the same principle, when the plug 10 is offered up to the base 21, the third electrical connector 35 is the electrical connector which is connected first.

Additionally, the recharging assembly can be configured in such a way as to generate a force along the first axis 52 substantially at right angles to the contact surface 11 passing through the first point of contact 51 to secure the electrical contact while the battery is recharging.

FIG. 6 schematically represents a cross-sectional view of the plug 10 of the recharging assembly 100 according to the invention. This cross-sectional view makes it possible to represent one possible configuration of a presence detector 33 on the contact surface 11 of the plug 10. Likewise, the magnetic connectors 13 are arranged alternately with the electrical connectors 12 so as to favor a good alignment of the electrical connectors 12 with the electrical connector 22 of the base 21.

FIG. 7 schematically represents a cross-sectional view of the plug 10 of the recharging assembly 100 according to the invention, the contact surface 11 of the plug 10 being in contact with the surface of the base 21 of the object 20. The magnetic connectors 13, 23 eliminate any mechanical guidance and work without a prioritized axis while the plug 10 is being offered up to the base 21. No particular guidance is necessary since no part is inserted into another. A relatively low accuracy of movement is sufficient for the plug 10 to be correctly positioned on the base 21.

Furthermore, the spherical arrangement of the electrical connectors eliminates the need for orientation in the plane of the contacts and does not impose any specific orientation of the electrical connectors when taking hold of the plug 10 to position it on the base 21.

FIG. 8 schematically represents a cross-sectional view of the object 20 of the recharging assembly 100 according to the invention. This cross-sectional view makes it possible to represent one possible configuration of the fourth electrical connector 45, positioned at the center of the surface of the base 21. The electrical connector of the base 21 is, in this configuration, a surface connector 24. As in FIG. 6, the magnetic connectors 23 are arranged alternately with the electrical connectors 45, 24 so as to promote a good alignment of the electrical connectors 12 with the electrical connectors of the base 21.

FIG. 9 illustrates the steps of a recharging method implementing a recharging assembly 100 according to the invention. The method comprises a step 1001 of positioning of the contact surface 11 of the plug 10 on the base 21 and a step 1002 of alignment of the first and second electrical connectors 22, 12.

The method can also comprises a step of activation 1003 of the recharging comprising the following steps:

Verification of the presence of the plug 10 on the object by the presence detector 33,

Measurement of the voltage at the terminals of the battery and comparison of the measured voltage to a minimum voltage value and a maximum voltage value,

Measurement of the internal resistance of the battery and comparison of the measured resistance to a minimum resistance value and a maximum resistance value.

The method also comprises a step 1004 of termination of recharging comprising the following steps performed in the following order:
Disconnection of the second electrical connector 12 and of the first electrical connector 22,
Disconnection of the fourth electrical connector 45 and of the third electrical connector 35.

FIG. 10 represents a humanoid robot configured to be recharged using a plug 10 of a recharging assembly 100 according to the invention. The robot 200 in FIG. 10 is taken as an example of a humanoid robot configured to be recharged using a plug 10 of a recharging assembly 100 according to the invention. The lower part of the robot 200 in FIG. 10 is not operational for walking, but can move in any direction on its plinth 140 which rolls on the surface on which the robot 200 is located. In this example, the robot 200 has a height 110 which can be approximately 120 cm, a depth 120 of approximately 65 cm and a width 130 of approximately 40 cm. In a specific configuration, the robot has a tablet 150 with which it can communicate messages (audio, video, Internet pages) to its environment, or receive user input through a touch interface of the tablet. In addition to the processor of the tablet, the robot also uses the processor of its own mother board which can for example be an ATOM™ Z530 board from Intel™. Advantageously, the robot also has a processor dedicated to the data streams between the mother board and the boards supporting the magnetic rotary sensors, abbreviated MRE for the term Magnetic Rotary Encoders, and sensors which control the motors of the articulations in a limb and the balls that the robot uses as wheels, in an embodiment of the invention. The motors can be of different types, depending on the amplitude of the maximum torque required for a defined articulation. For example, coreless DC brush motors from e-Minebea™ (SE24P2CTCA for example) can be used, or brushless DC motors from Maxon™ (EC45_70 W for example). The magnetic rotary sensors preferentially use the Hall effect, with a precision of 12 or 14 bits.

The robot illustrated in FIG. 10 can also comprise different types of sensors. Certain sensors are used to control the position and the movements of the robot. Such is the case, for example, of an inertial unit located in the torso of the robot and comprising a 3-axis gyrometer and a 3-axis accelerometer. The robot can also include two RGB color 2D cameras on the front of the robot (top and bottom) of the system on chip (or SOC) type, such as those from Shenzen V-Vision Technology Ltd™ (OV5640), with a resolution of 5 megapixels at five images per second and a field of view (also called FOV) of approximately 57° horizontal and 44° vertical. A 3D sensor can also be included behind the eyes of the robot, such as the ASUS XTION™ SOC sensor with a resolution of 0.3 megapixels at 20 images per second, with approximately the same field of view as the 2D cameras. The robot can also be equipped with laser line generators, for example three at the head level and three in the base, so as to be capable of detecting its relative position in relation to objects and/or human beings in its environment. The robot can also include microphones to be able to detect sounds in its environment. In one embodiment, four microphones with a sensitivity of 300 mV/Pa+/−3 dB at 1 kHz and a frequency range of 300 Hz to 12 kHz (−10 dB relative to 1 kHz) can be implanted in the head of the robot. The robot can also include two sonar sensors, possibly positioned in front of and behind its base, for measuring the distance which separates it from objects and/or human beings in its environment. The robot can also include touch sensors, on its head and on its hands, to allow interactions with human beings. It can also include bumpers on its base to protect itself from obstacles that it encounters in its path.

To reflect its emotions and communicate with the human beings in its environment, the robot can also include:

LEDs, or light-emitting diodes, for example in its eyes, its ears and on its shoulders;
loudspeakers, for example two of them, located in its ears.

The robot can communicate with a base or with other robots through an Ethernet RJ45 or WiFi 802.11 connection.

The robot can be powered by a lithium iron phosphate battery with an energy of approximately 400 Wh or lithium polymer trimix (lithium cobalt manganese) battery of approximately 860 Wh. The robot can access a recharging device suited to the type of battery that it contains.

The position and the movements of the robot are controlled by its motors, by using algorithms which are activated by chains defined in each limb and effectors defined at the termination of each limb, given measurements from the sensors.

To be recharged using a recharging assembly 100 according to the invention, the robot 200 comprises a base 21 capable of receiving the plug 10. It acts here as an example of object to which the recharging assembly 100 can be applied.

1. A recharging assembly comprising:
an object comprising a battery,
a plug intended to recharge the battery, the plug being able to be connected to a power source,
wherein the object comprises:
a base capable of receiving the plug, comprising:
a first electrical connector,
a first magnetic connector capable of positioning the plug relative to the base,
wherein the plug comprises:
a contact surface of a form complementing a surface of the base,
a second electrical connector arranged so as to enter into contact with the first electrical connector to allow an electrical contact between the first and second electrical connectors when the contact surface is positioned on the surface of the base,
a second magnetic connector, positioned in proximity to the contact surface, attracting the first magnetic connector, so as to allow the alignment of the first and second electrical connectors and the electrical contact to be secured while the battery is recharging,
in that one out of the first and the second electrical connectors is a surface connector and the other out of the first and the second electrical connectors is a spot connector arranged so as to be placed against the surface connector, for several distinct orientations of the contact surface on the base,
in that the plug can be connected to the power source by an electrical cable, in that the plug comprises:
a body to which the second electrical connector and the second magnetic connector are fixed,
a mobile part that is rotationally mobile relative to the body, the cable being fixed to the mobile part and linked electrically to the connectors by flexible wires allowing the rotation of the mobile part.

2. The recharging assembly as claimed in claim 1, wherein the surface connector has a circular form.

3. The recharging assembly as claimed in claim 1, further comprising a presence detector capable of detecting a contact between the contact surface and the surface of the base.

4. The recharging assembly as claimed in claim 1, the spot connector forming a first point of contact with the contact surface, wherein the assembly is configured in such a way that one out of the first and the second electrical connectors has a degree of freedom in translation relative to the contact surface along a first axis substantially at right angles to the contact surface passing through the first point of contact.

5. The recharging assembly as claimed in claim 1, the spot connector forming a first point of contact with the contact surface, wherein the assembly is configured in such a way as to generate a force on the first axis substantially at right angles to the contact surface passing through the first point of contact to secure the electrical contact while the battery is recharging.

6. The recharging assembly as claimed in claim 1, wherein the base comprises a cavity having the complementary form of a spherical cap having a first pole and a first radius, in that the plug has the form of a spherical cap having a second pole and of a radius substantially equal to the first radius, and in that the surface connector is centered on a circle whose center is the first pole.

7. The recharging assembly as claimed in claim 6, wherein the plug comprises a third electrical connector positioned on the second pole of the plug, and the base comprises a fourth electrical connector positioned on the first pole of the base, so as to enter into contact with the third electrical connector to allow an electrical contact between the third and fourth electrical connectors when the contact surface is positioned on the base.

8. The recharging assembly as claimed in claim 7, wherein the power source is a DC voltage source with a positive pole and a negative pole, in that the third electrical connector is connected to the negative pole of the power source and in that the second electrical connector is connected to the positive pole of the power source.

9. The recharging assembly as claimed in claim 1, wherein the contact surface comprises a flexible zone having a degree of freedom in translation along a second axis substantially at right angles to the first axis, intended to facilitate the contact of the second electrical connector with the first electrical connector when the contact surface is positioned on the base.

10. A recharging method implementing a recharging assembly as claimed in claim 1, further comprising the following steps:
Positioning of the contact surface on the surface of the base,
Alignment of the first and second electrical connectors.

11. The recharging method as claimed in claim 10, wherein the recharging assembly comprises a presence detector capable of detecting a contact between the contact surface and the surface of the base, further comprising a step of activating of the recharging comprising the following steps:
Verification of the presence of the plug on the object by the presence detector,
Measurement of the voltage at the terminals of the battery and comparison of the measured voltage to a minimum voltage value and a maximum voltage value,
Measurement of the internal resistance of the battery and comparison of the measured resistance to a minimum resistance value and a maximum resistance value.

12. The recharging method as claimed in claim 10, wherein the recharging assembly comprises a third electrical connector positioned on the second pole of the plug, and the base comprises a fourth electrical connector positioned on the first pole of the base, so as to enter into contact with the third electrical connector to allow an electrical contact between the third and fourth electrical connectors when the contact surface is positioned on the base, further comprising a step of termination of recharging comprising the following steps performed in the following order:
Disconnection of the second electrical connector and of the first electrical connector,
Disconnection of the fourth electrical connector and of the third electrical connector.
